(19) United States
(12) Patent Application Publication
(10) Pub. No.: US 2014/0067693 A1
(43) Pub. Date: Mar. 6, 2014

(54) TECHNOLOGY TRANSITION FRAMEWORK

(71) Applicant: Schlumberger Technology Corporation, Sugar Land, TX (US)

(72) Inventors: Fausto Alvarez Hernandez, Houston, TX (US); Stephen Ashley, Houston, TX (US); Juan Carlos Gonzalez Bonilla, Kuala Lumpur (MY); Giles Denby, Kuala Lumpur (MY); Paul Galinski, Sugar Land, TX (US); Sebastien Geoltrain, London (GB); Espen Osjord, Hafrsfjord (NO); Jonathan Scarf, Godalming (GB); Rosemarie Waiand, Jersey Village, TX (US); Stephen Warner, Buckinghamshire (GB); Stephane Emmanuel Paul Bonnassies, Houston, TX (US); Munawar Ahmad Butt, Orpington (US); Antoine Frichet, Paris (FR); Armando Gomez, Kuala Lumpur (MY); Bryan Johnston, Berkshire (GB); Todd Olsen, Spring, TX (US); Dany Rahal, London (GB); Lawrence Wood, Dubai (AE); Yuhua Zhang, Nei Mongol (CN)

(73) Assignee: Schlumberger Technology Corporation, Sugar Land, TX (US)

(21) Appl. No.: 14/012,030

(22) Filed: Aug. 28, 2013

Related U.S. Application Data
(60) Provisional application No. 61/693,917, filed on Aug. 28, 2012.

(51) Int. Cl. G06Q 10/10

(52) U.S. Cl. CPC G06Q 10/101
USPC 705/301

(57) ABSTRACT

A method for deploying a product through multiple phases includes defining work streams for deploying the product, where each work stream is defined for a set of components of a client environment. For each work stream and for each phase, a set of predefined tasks are identified for the phase, a computer processor gathers for the phase a set of instruments specific to the work stream for performing the set of predefined tasks, and the set of instruments are stored in a data repository of a deployment framework. The set of predefined tasks for the phase is common amongst the work streams.

### CROSSREFERENCE TO RELATED APPLICATIONS

This application claims benefit under 35 U.S.C. §119(e) of U.S. Provisional Patent Application No. 61/693,917, filed on Aug. 28, 2012, and entitled “Technology Transition Framework,” which is hereby incorporated by reference.

### BACKGROUND

A computer system includes software and hardware. Different types of software may execute on the same set of hardware. The interrelationship between the different types of software and the hardware provide functionality to the computer system and allows users to achieve their business objectives. Medium to large size businesses may have complex systems. Such complex systems often includes multiple different software packages, several servers, and propriety equipment. To add to the complexity, users at the businesses may have a widely varying degree of computing competency. Because of the complexity, changing a component of a business' system is an intricate process involving management of the interrelationships between the various components of the business' system.

### SUMMARY

In general, in one aspect, embodiments relate to a method for deploying a product through multiple phases. The method includes defining work streams for deploying the product, where each work stream is defined for a set of components of a client environment. For each work stream and for each phase, a set of predefined tasks are identified for the phase, a computer processor gathers for the phase a set of instruments specific to the work stream for performing the set of predefined tasks, and the set of instruments are stored in a data repository of a deployment framework. The set of predefined tasks for the phase is common amongst the work streams.

In general, in one aspect, embodiments relate to a deployment framework that include a data repository storing a set of instruments, and a computer processor. The computer processor, when executing a deployment application, creates a customization interface configured to receive work streams, present multiple phases for each work stream, and, for each phase, receive the set of instruments for completing tasks of the phase, and store the set of instruments. The task common to each of work streams. The set of instruments is defined for the phase and a work stream of the multiple work streams. The computer processor, when executing the deployment application, further creates a deployment interface configured to receive a selected work stream from the and a selected phase, and present, in response to receiving the selected phase and the selected work stream, the instruments corresponding to the selected work stream and the selected phase.

In general, in one aspect, embodiments relate to a non-transitory computer readable medium that includes computer readable program code for deploying a product through multiple phases. The computer readable program code is for defining multiple work streams for deploying the product, where each work stream is defined for a set of components of a client environment. The computer readable program code is further for performing, for each work stream of the multiple work streams and for each phase of the multiple phases, identifying a set of predefined tasks for the phase, gathering, for the phase, a set of instruments specific to the work stream for performing the set of predefined tasks, and storing the set of instruments in a data repository of a deployment framework. The set of predefined tasks for the phase is common amongst the plurality of work streams.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

Embodiments of technology transition framework are described with reference to the following figures. The same numbers are used throughout the figures to reference like features and components.

FIGS. 1-4 show schematic diagrams in one or more embodiments.

FIGS. 5-9 show flowcharts in one or more embodiments.

FIG. 10 shows a computer system in accordance with one or more embodiments.

FIG. 11 shows an example in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that the invention may be practiced without these specific details. In other instances, well-known features have not been described in detail to avoid unnecessarily complicating the description.

In the following description and claims a set refers to a group of one or more items that share a common feature. Thus, although a set may be defined with respect to a plural form of the item (e.g., “set of items”), the set may include only a single item without departing from the scope of the claims.

In general, embodiments provide a technology transition framework for deploying a product on a client's system. Specifically, the technology transition framework is a prescription for deployment of software and/or hardware technology in a business environment, whose outcome is vested in a population of knowledge workers and/or in a business service in accordance with one or more embodiments. Thus, the technology transition framework provides a defined multi-phase guide to deploying a product on a client's system. Each phase has a set of tasks that are predefined for that phase. Moreover, the technology transition framework simplifies the deployment of the product by separating the deployment into multiple work streams. Each work stream represents a subset of components of the client's system. For each phase and work stream, the technology transition framework provides a set of instruments that simplify the execution of tasks in the phase.

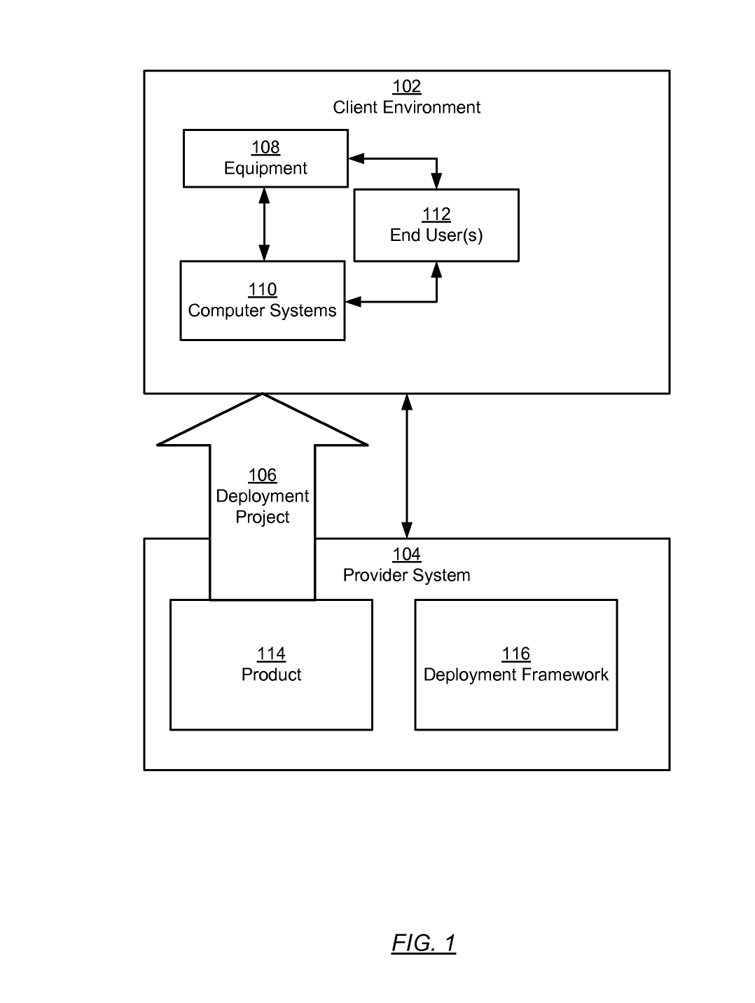

FIG. 1 shows a schematic diagram for a deployment project (106) in one or more embodiments. A deployment project (106) is the set of activities for deploying a product (114) on a client environment (102). As shown in FIG. 1, the system includes a client environment (102) and a provider system (104) in one or more embodiments. The client environment (102) corresponds to a receiver of the deployment project (106). The client environment (102) may include equipment (108), computer systems (110), and end user(s) (112). Each of these components is discussed below.

In one or more embodiments, the equipment (108) is the physical machinery used by the client in the client's operations. Specifically, the physical machinery is the specific machinery that is capable of producing the client's goods and/or services. In one or more embodiments, the equipment (108) is operatively connected to computer systems (110).

The computer systems (110) correspond to the hardware and software that are used in the operations of the client's business. Specifically, the computer systems (110) may include storage servers, application servers, network terminals, individual end users' computing devices. The computer systems may also include software, such as data management applications, operations analysis applications, applications for monitoring and collecting data from the equipment (108), applications for controlling the operations of the equipment (108), applications for managing the client's business, and other such applications.

For example, consider the scenario in which the client performs oilfield operations. In such a scenario, the equipment may include physical machinery for drilling and production operations, such as the drilling rig, the drill string, surface sensors, downhole sensors, cameras, and other components used to obtain hydrocarbons. The computer systems (110) are connected to the oilfield equipment and include functionality to receive data, monitor, analyze, and control the oilfield equipment. Specifically, the computer systems (110) may include functionality to gather data directly from the sensors and store the data in a database on the computer systems. The computer systems (110) may also include functionality to analyze the data to identify geological formations and to determine where hydrocarbons may be present in the geological formations, to identify fault or failure of the oilfield equipment or geological formation of the oilfield, to calculate the amount of hydrocarbons being produced and/or expected to be produced at the oilfield, to control the flow of hydrocarbons through production pipeline networks connecting multiple wellsites, to control drilling speed and direction, and perform other tasks that are related to the development of an oilfield.

The above example functions may be performed by the same software or different software executing on the same or different physical device. For example, one application may include functionality to gather data directly from the sensors and populate a database on a database server. Another application executing on an application server or an end user's computing device may include functionality to obtain the data from the database server and analyze the flow of hydrocarbons through a pipeline production network. Another application may send control signals to individual well sites to change the amount of hydrocarbons produced at the well site based on the flow through the hydrocarbon pipeline production network. Additionally, applications may exist to manage the business processes, such as communications between computing devices, create firewalls, and perform other tasks.

Continuing with FIG. 1, one or more end users (112) interact with the equipment (108) and computer systems (110). For example, the end users may correspond to employees and contractors of the client. The end users may have a varying set of skills For example, some end users may be highly proficient at using the various software and hardware of the client's computer systems (110) and/or equipment (108) while other end users require intensive training to use the client's computer systems (110) and/or equipment (108).

The client environment (102) is connected to a provider system (104) in one or more embodiments. The provider system (104) is the provider of a product (114). For example, the provider system (104) may be an internal information technology department of the client environment (102), a vendor of software and/or hardware, an equipment manufacturer and/or distributor, or another such entity. The provider system (104) includes a product (114) and a deployment framework (116).

In one or more embodiments, the product (114) is the item being deployed on the client environment (102). In one or more embodiments, the product (114) is a commercial product that is developed for an entire market of consumers. In other words, although the product may be customized by configuration for a particular customer, the product is not developed for the particular client environment (102), but rather for an entire market of customers. Thus, the particular customer on which the product is being deployed does not dictate or define the requirements for the product when or prior to development (e.g., does not define the requirements documentation). The product (114) may be an enterprise application, a piece of software, hardware, equipment, etc., or a combination thereof. For example, the product (114) may correspond to equipment and software for designing, modeling, forecasting, and operating hydrocarbon extraction. The product (114) may be licensed commercial software, such as licensed commercial software that is developed for a market of hydrocarbon extraction companies.

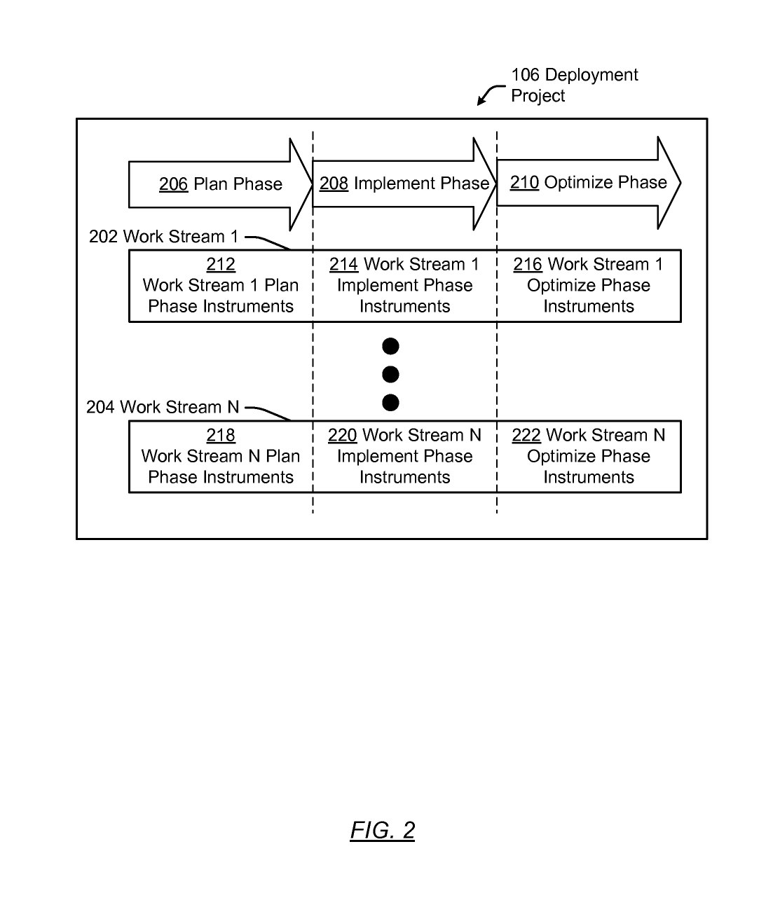

A version of the product (114) (referred to herein as “deployed product”) is deployed on the client environment (102). The deployed product is version configuration of the product (114) that is customized for the client. Specifically, the deployed product is a configuration that satisfies the requirements and is capable of operating in the client environment (102) (e.g., specific equipment (108), specific computer systems (110), and end users (112)). If multiple client systems exist, some or all clients may have the same product. However, that same product is customized through the deployment project (106) for each client environment (102). In other words, a deployment project (106) is the set of tasks for deploying a customized version of the product (114) for the client environment (102). The deployment project (106) is discussed in further detail below and in FIG. 2 in one or more embodiments.

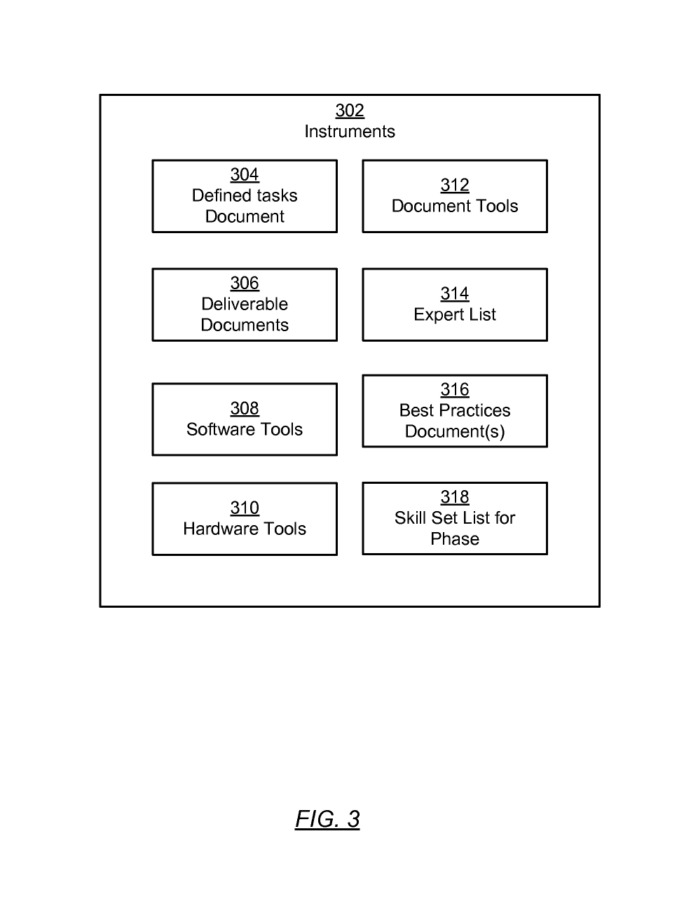

In one or more embodiments, the deployment framework (116) is a framework for deploying the product (114) on the client environment (102). The deployment framework (116) may correspond to hardware, software, or combination thereof and provides an organized structure for deploying any product on a client environment (102). In one or more embodiments, the deployment framework (116) is customized for the product (114). In particular, a general deployment framework exists that defines general phases and tasks for deploying any product. The general deployment framework may be customized by identifying and adding work streams (discussed below and in FIG. 2) and instruments (discussed below and in FIG. 3) for the general phases and tasks. Once customized, the deployment framework assists in the deployment and, thus, customization of the particular product (114) on any client environment (102). In one or more embodiments, deployment of the product (114) is partitioned into phases.

FIG. 2 shows a schematic diagram of deployment project (106) in one or more embodiments. As shown in FIG. 2, the deployment project (106) includes work streams (e.g., work stream 1 (202), work stream N (204)) and phases (e.g., a plan phase (206), an implement phase (208), an optimize phase (210)). Both of these aspects of a deployment project (106) are discussed below.

A work stream (e.g., work stream 1 (202), work stream N (204)) corresponds to the series of discrete tasks, grouped into the phases, whereby each of the tasks are defined for the same particular component or set of components of the client environment. For example, one work stream may be defined to migrate end users at the client environment to the deployed product while another work stream may be defined for performing data migration. Similarly, another work stream may be defined to update the client's physical infrastructure to accommodate the deployed product. In one or more embodiments, the existence of multiple separate work streams may simplify the deployment project by having each work stream focus on a part of the components of the client environment.

Each work stream (e.g., work stream 1 (202), work stream N (204)) is partitioned into a plan phase (206), an implement phase (208), and an optimize phase (210). In one or more embodiments, the same set of tasks for a particular phase are in each work stream regardless of the work stream or the product. In other words, each phase has a set of generally defined tasks. By organizing each phase into a set of generally defined tasks, customizing the deployment framework is simplified as the generally defined tasks act as a template.

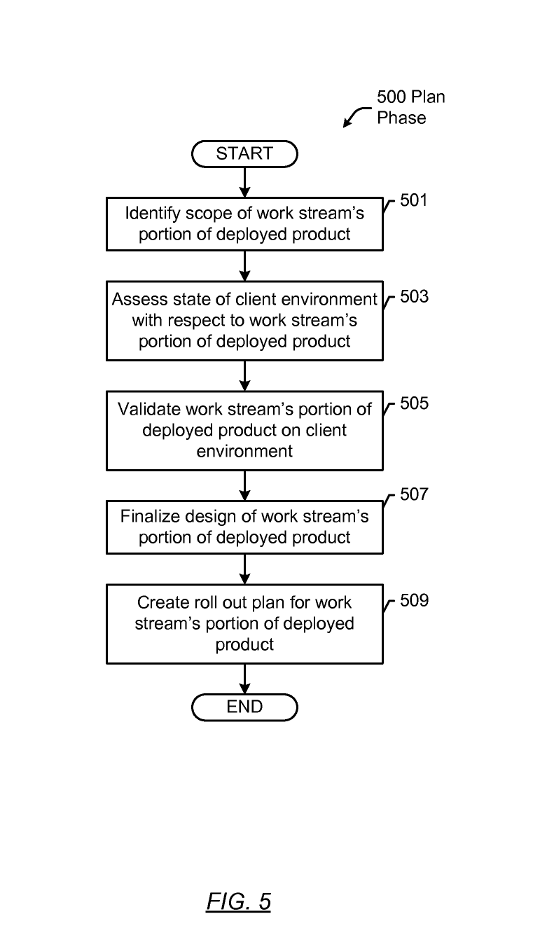

During the plan phase (206) of a work stream, a plan is created to deploy the product on the client environment. In other words, the plan phase defines for a particular work stream how the deployment of the product is to occur. In one or more embodiments, the plan phase occurs after the product is fully developed. For example, during the plan phase, the requirements and components of the client environment are identified, the deployment project is defined and validated to conform to the requirements and components, and a deployment plan is defined. As an example, for an end user level work stream, the plan phase may include, among other tasks, determining what the end user's needs are with respect training and support, determining the amount of training and support for solving the end user's needs, and creating a plan to provide the training and support. As another example, for a data migration work stream, the plan phase may include, among other tasks, determining a profile of the data volumes and data types at the client is determined, determining the amount of reconciliation required (e.g., to remove duplicated entries, to identify dormant projects to be archived, to archive data no longer needed, to perform data type translation, etc.), identifying the time and cost estimates to perform the data migration, and creating a plan to perform the data migration. The plan phase is discussed in more detail in FIG. 5 below in one or more embodiments.

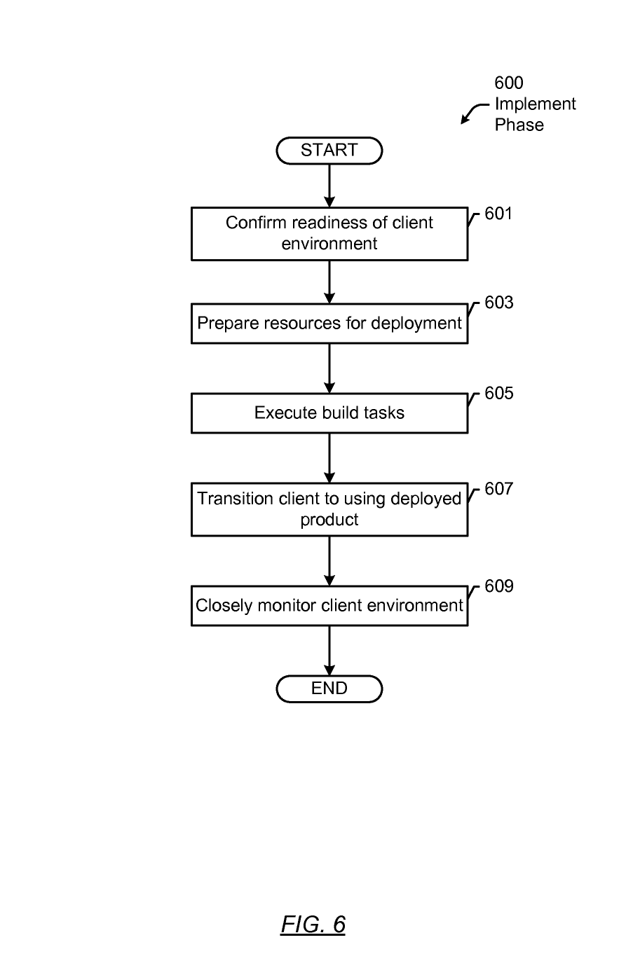

Continuing with FIG. 2, during the implement phase (208) of a work stream, the deployment plan is implemented in one or more embodiments. For example, the product is deployed on the client environment and the client is transitioned to using the product. As an example, for the end user level work stream, the resources required for performing the support and training are gathered, training sessions are performed, end users are transitioned to using the deployed product with support and training during the day of the transition, and for several days after, the end users may be monitored. As another example, for data migration, the data volumes of the client environment are checked to determine whether they are ready for migration, resources (e.g., manpower and servers) are gathered to perform the migration, the data is migrated to be used with the deployed product, the deployed product starts using the migrated data, and the data volumes are monitored to confirm that the correct data is being generated given the migrated data. The implement phase is discussed in more detail below and in FIG. 6 in one or more embodiments.

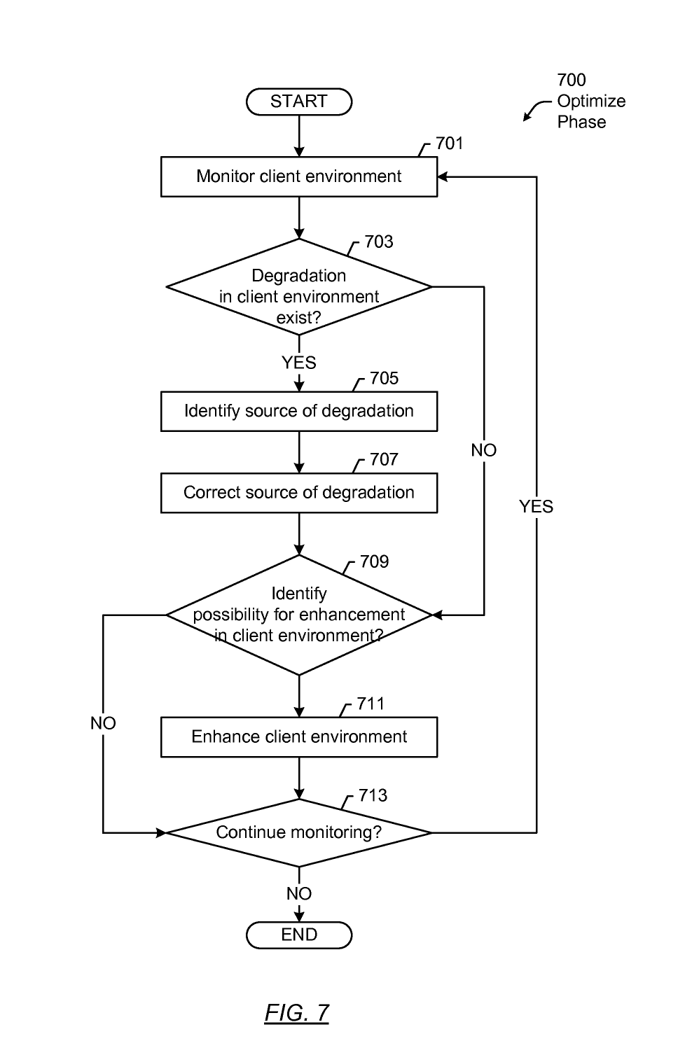

Continuing with FIG. 2, the optimize phase (210) in one or more embodiments is a continual phase to monitor and optimize the deployed product. For example, in one or more embodiments, degradations in the execution of the deployed product are identified and corrected. As an example, for the end user level work stream, the end user's use of the deployed product is monitored to confirm that the end users are using the deployed product as intended and to determine whether further training is required. Additionally, in one or more embodiments, the end user's use of support is monitored to determine whether the end users are requesting support when needed and to determine whether the support provided is adequately addressing the needs of the end users. As another example, for the data migration work stream, data validation is performed to confirm that the dataset remains accurate and without duplicates or degradation. In one or more embodiments, the optimize phase is discussed in further detail below and in FIG. 7.

Each of the work streams are customized by use of a specific set of instruments defined for each phase (e.g., work stream 1 plan phase instruments (212), work stream 1 implement phase instruments (214), work stream 1 optimize phase instruments (216), work stream N plan phase instruments (218), work stream N implement phase instruments (220), work stream N optimize phase instruments (222)). Specifically, work stream 1 (202) instruments may be different than work stream N (204) instruments. In general, an instrument is an item that assists in performing the phase for the particular work stream. Specifically, an instrument may be a document, a tool, or other such items for performing the phase.

FIG. 3 shows an example set of instruments (302) in one or more embodiments. As shown in FIG. 3, the instruments (302) may include one or more defined tasks documents (304), one or more deliverable documents (306), one or more software tools (308), one or more hardware tools (310), an expert list (314), one or more document tools (312), one or more best practices documents (316), and a skill set list (318). Each of these example types of instruments are discussed below.

In one or more embodiments, a defined tasks document (304) is a document that specifies the set of tasks to complete the phase. Specifically, for each general task in the phase, the defined tasks document (304) provides a set of tasks that is involved in completing the task for a particular work stream.

In one or more embodiments, deliverable documents (306) describes the goals for the particular phase and work stream. Specifically, the deliverable documents (306) defines what performing the particular phase in the work stream should achieve. In other words, the deliverable documents (306) defines the desired result of the particular phase of the work stream. For example, the deliverable document (306) for the optimize phase of the data migration work stream may be a definition of the major processes, requirements, and targets; a defined standard structured report and a media for reporting; and a report on expectations and actual results.

In one or more embodiments, the software tool(s) (308) correspond to one or more applications that may be used to perform the tasks of the phase. For example, the software tool(s) (308) may include software probes for monitoring executing software and hardware, fault management software for gathering data from hardware and equipment, integrated development environments, project management software, provisioning software, presentation software, and other software tools that may be used to complete a task.

In one or more embodiments, hardware tool(s) (310) correspond to physical devices and computer hardware that may be used to perform tasks of the phase. For example, hardware tool(s) (310) may include storage servers, provisioning servers, hardware sensors for measuring the client's hardware, and other hardware tool(s).

In one or more embodiments, document tools (312) are documents that are used to perform the phase. For example, document tools may include templates for reporting, presentations for demonstrating the product during a tutorial session, a collection of documents for conducting a workshop (e.g., handouts, agenda, examples, presentations), and other types of tools that are used to perform the task of the particular phase.

In one or more embodiments, an expert list (314) is a list of individuals that are experts in performing the tasks of the phase for the particular workflow and project. The expert list (314) may include contact information for the experts.

In one or more embodiments, the best practices documents (316) describe best practices for performing the phase. Specifically, the best practices documents provides details regarding how each task may be achieved based on the past experiences of personnel during the performance of the task. For example, a best practice may indicate when standards for naming conventions should be decided, what methods may be used to achieve the tasks, a list of do's and don'ts for performing the task, and other such practices.

In one or more embodiments, a skill set list (318) is a list of skills required for a person performing the phase. For example, the skill set list may indicate that the person should have consulting and interviewing skills, that they should have experience with a particular equipment or software product, know a particular programming language, and/or have another skill

Continuing with the discussion of the deployment framework, in one or more embodiments, the deployment framework includes functionality to guiding personnel to create instruments and/or add references to existing instruments. In other words, the deployment framework provides an organization to deploying a project.

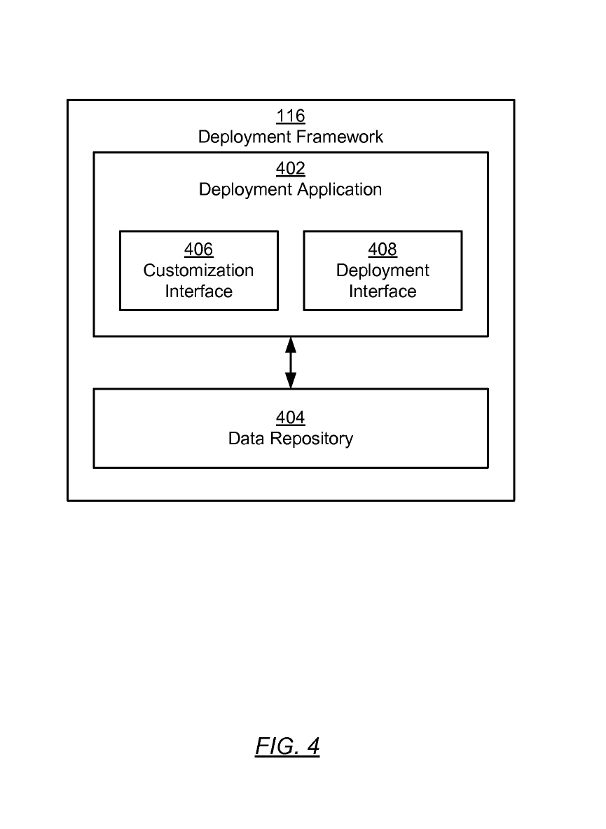

FIG. 4 shows a schematic diagram of the deployment framework (116) in one or more embodiments. As shown in FIG. 4, the deployment framework (116) includes a deployment application (402) and a data repository (404). Both of these components are discussed below.

In one or more embodiments, the deployment application (402) is a software application to assist in the deployment of a product. Specifically, the deployment application (402) includes a customization interface (406) and a deployment interface (408). Both of these components are discussed below.

The customization interface (406) is a user interface for guiding a user to customize the deployment framework (116). Specifically, the customization interface guides the user at the provider to create work streams and to provide a set of instruments for each phase and task in the work streams. The customization interface (406) may be implemented as a set of one or more templates. Each template may correspond to a portion of the general deployment framework. The customization framework may be an application that, through a set of questions, allows the user at the provider to create the work streams and provide instruments. In one or more embodiments, once customized for a particular product, the customized deployment framework may be used to deploy the particular product at any client.

In one or more embodiments, the deployment interface (408) is an interface for deploying the product at the particular client. Specifically, the deployment interface (408) is a user interface that presents tracking information to users to track which phase and work stream the user is currently in, and instruments and/or references to instruments for each phase and work stream. More specifically, the deployment interface organizes instruments according to the phase and work stream. Thus, a user at the provider may navigate to the particular phase and work stream to obtain the instruments for the particular phase and work stream. In one or more embodiments, the deployment interface is a web based graphical user interface.

Continuing with FIG. 4, in one or more embodiments, the data repository (404) is any type of storage unit and/or device (e.g., a file system, database, collection of tables, or any other storage mechanism) for storing data. Further, the data repository (404) may include multiple different storage units and/or devices.

The multiple different storage units and/or devices may or may not be of the same type or located at the same physical site. In one or more embodiments, the data repository (404), or a portion thereof, is secure. In one or more embodiments, the data in the data repository include instruments, such as the instruments shown in FIG. 3, and code for the deployment application (402).

FIGS. 5-9 show flowcharts in one or more embodiments. While the various blocks in these flowchart are presented and described sequentially, one of ordinary skill having benefit of the disclosure will appreciate that some or all of the blocks may be executed in different orders, may be combined or omitted, and some or all of the blocks may be executed in parallel. Furthermore, the blocks may be performed actively or passively. For example, some blocks may be performed using polling or be interrupt driven in accordance with one or more embodiments. By way of an example, a determination may not require a processor to process an instruction unless an interrupt is received to signify that condition exists in accordance with one or more embodiments. As another example, determination blocks may be performed by performing a test, such as checking a data value to test whether the value is consistent with the tested condition in accordance with one or more embodiments.

FIG. 5 shows a flowchart for the plan phase (500) in one or more embodiments. In one or more embodiments, the tasks shown in FIG. 5 are the generalized tasks defined by the deployment framework to deploy a product. Each of the generalized tasks shown in FIG. 5 are customized for the product and the work stream using instruments in one or more embodiments.

In 501, the scope of the work stream's portion of the deployed product is identified in one or more embodiments. In one or more embodiments, scoping includes the client and provider agreeing as to the objectives, success criteria, and constraints of the work stream portion of the project. Scoping may include identifying possible challenges during the transition and creating a high level plan for the transition. For example, if the work stream is for managing the client's infrastructure change during the deployment of the product, then the objectives may be the speed of operating, the constraints may include the time period in which the infrastructure is non-functional during the transition, and success criteria may include the allowable failure rate of the infrastructure after the deployment. Instruments for the scoping task may include, for example, meeting agendas, workshop documents, high level requirement documents, and deliverable documents defining what should be the result of meetings, as well as other instruments, such as those presented above and in FIG. 3.

In 503, the state of the client environment with respect to the work stream's portion of the deployed product is assessed in one or more embodiments. In one or more embodiments, the assessment stage assesses the current state of the client environment in relation to the work stream. For example, during the assessment stage for end user training, the current state may be the skill level of the end users at the client have with the particular type of product. During the assessment stage for workflow consolidation, the current software portfolio may be assessed, the number of licenses versus the number of end users may be identified, whether the current software is satisfying the requirements of the client may be determined, and other such information. Instruments for the assessment task may include, for example, templates, software probes, meeting agendas, best practices, hardware sensors, and other instruments, such as those presented above and in FIG. 3.

In 505, the work stream's portion of the deployed product is validated on the client environment in one or more embodiments. In one or more embodiments, during validation, the scope is compared with the state of the client environment to ensure that the work stream's portion of the deployed project matches the client's requirements and does not conflict with any part of the existing state of the client environment.

In 507, the design of the work stream's portion of the deployed product is finalized in one or more embodiments. The final agreement is obtained as to the work stream's portion of the deployed project.

In 509, a roll out plan for the work stream's portion of the deployed product is created in one or more embodiments. Specifically, the roll out plan defines how transitioning occurs for the work stream's portion of the deployed product. For example, for end user training, the roll out plan may include when end user training occurs, and how end user training will be provided during the first day the deployed product is live. For the workflow consolidation work stream, the roll out plan defines the time and date when the deployed project goes live, whereby end users at the client environment start using the deployed project.

In one or more embodiments, once the plan phase is completed, the work streams may proceed to the implement phase. In one or more embodiments, all work streams wait until every work stream has completed the plan phase to move to the implement phase. In one or more embodiments, some or all work streams may

FIG. 6 shows the implement phase (600) in one or more embodiments. In 601, the readiness of the client environment is determined in one or more embodiments. The readiness task for the workflow's portion may include performing final validation of the design consistency and completeness of the workflow's portion of the deployed product. Further, the readiness task may also include verifying that the client has the required infrastructure and tools.

In 603, resources are prepared for deployment in one or more embodiments. In one or more embodiments, preparation of resources include identifying deployment project team members for the particular work stream, scheduling resources for the deployment, and/or performing other tasks to prepare for the transition.

In 605, build tasks are executed in one or more embodiments. In one or more embodiments, the build tasks include production of the deliverables of the work stream per the design. For example, for the workflow consolidation work stream, the product may be customized per the client requirements developed during the planning phase. For the data migration work stream, scripts may be generated and/or executed to migrate the data to the developed product. For the end user training work stream, training sessions may be provided to the end users at the client. Instruments used for the build task for a work stream may include an integrated development environment, training session presentations and agendas, documentation for data format requirements for the product, and other instruments.

In 607, the client is transitioned to using the deployed product in one or more embodiments. In one or more embodiments, the client takes ownership of the deployed product. In one or more embodiments, instruments that may be used include support documentation, best practices documentation, provisioning servers, and/or other instruments.

In 609, the client environment is closely monitored in one or more embodiments. Specifically, during the initial time period after the client is transitioned, active support is provided and identified problems are quickly addressed. Each workflow performs the close monitoring to ensure that the client can use the product. Instruments that may be used during the close monitoring tasks may include benchmarking tools, data transfer design verification tools, data quality reporting tools, best practices documentation, and other instruments.

In one or more embodiments, once the implement phase is completed, the client has completed transitioning to the deployed product. Accordingly, the work stream may proceed to the optimize phase. FIG. 7 shows a flowchart for the optimize phase in one or more embodiments.

In 701, the client is monitored in relation to the work stream's portion of the deployed product in one or more embodiments. Specifically, the monitoring of the client is performed on a particular level of the work stream. For example, for the end user level, the monitoring may include determining whether end users are continuing to use the product, how the end users are using the product, and whether technical support is being provided to the end users in a timely manner. As another example, for the workflow consolidation, the monitoring may include determining how quickly the product is providing information, whether the product is exhibiting faulty behavior, and other such information. Instruments used during the monitoring task may include questionnaires, technical assistance reports, results from hardware sensors, results from software probes, and other instruments.

In 703, a determination is made whether degradation in the client environment exists in one or more embodiments. If degradation in the client environment is identified, then the flow may proceed to 705. If degradation in the client environment is not identified, then the flow may proceed to 709.

In 705, a source of the degradation is determined in one or more embodiments. Specifically, the cause of the degradation is identified. Identifying the cause of the degradation is dependent on the work stream and may be performed using the instruments for the work stream in one or more embodiments.

In 707, the source of the degradation is corrected in one or more embodiments. Correcting the source of the degradation may include, for example, replacing hardware, replacing equipment, modifying software, providing additional training, and performing other tasks. In one or more embodiments, solving the source of the degradation is performed on a per work stream basis while simultaneously accounting for other work streams. Specifically, solving the source of a degradation in the workflow consolidation work stream may require additional training to be provided in the end user level work stream.

Continuing with FIG. 7, in 709, a determination is made whether a possible enhancement for the client environment exists. For example, as new technology is developed the new technology may be used to enhance the deployed product on the client environment. If a possible enhancement is identified, the flow proceeds to 711, where the client environment may be enhanced. In one or more embodiments, although not shown in FIG. 7, enhancing the client environment may include validating the change and performing other such tasks to minimize the disruption to the client environment. Further, although not shown in FIG. 7, the determination in block 709 may also include determining whether to enhance the client environment even if such enhancement exists. Such determination may account for the business objectives and constraints of the client.

In 713, a determination is made whether to continue monitoring of the client environment. In one or more embodiments, monitoring of the client environment is an on-going process that stops when the product or client is no longer supported.

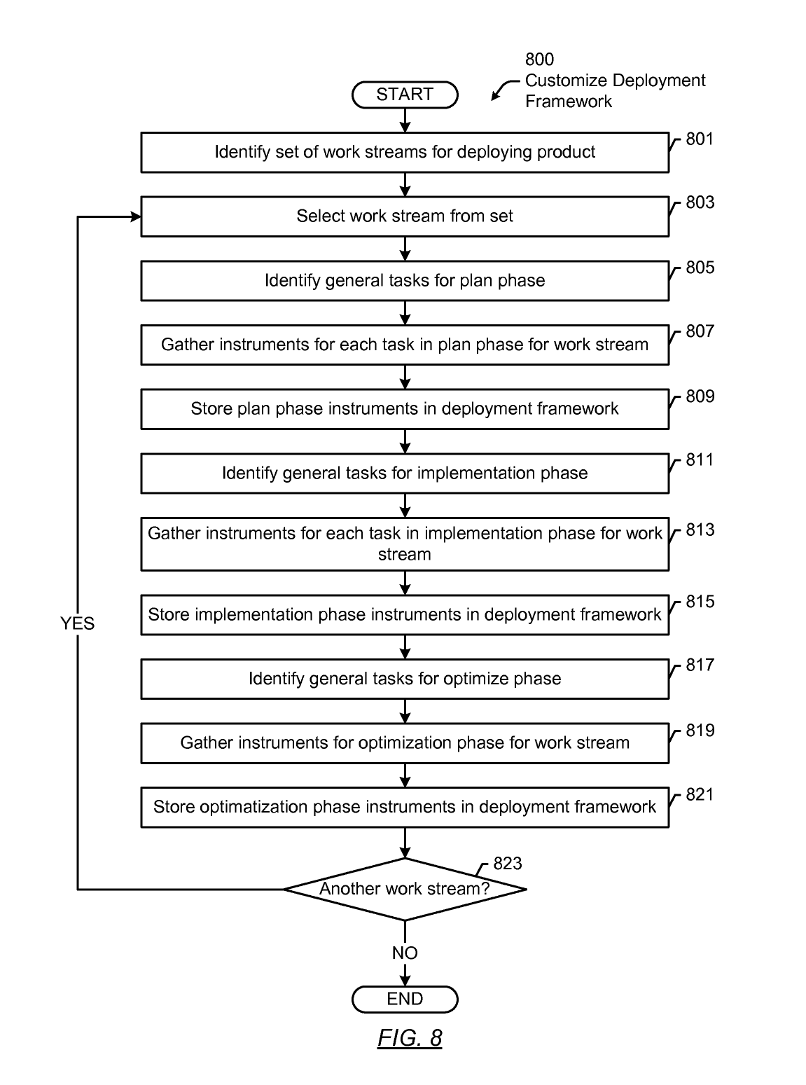

FIG. 8 shows a schematic diagram for customizing the deployment framework (800) in one or more embodiments. In one or more embodiments, although FIG. 8 shows the customization being performed sequentially, the customization may be performed in parallel. For example, multiple users at the provider may customize the deployment framework, whereby each user or set of users is responsible for a particular work stream.

In 801, the set of work streams for deploying the product are identified in one or more embodiments. Specifically, the deployment framework may present the user with a list of possible work streams. The user may select which work streams are relevant to the product. The user may also add work streams that the user identifies as required for the particular product.

In 803, a work stream is selected from the set of work streams in one or more embodiments. Specifically, the user may select the work stream from the customization interface in one or more embodiments.

In 805, general predefined tasks for the plan phase are identified in one or more embodiments. In one or more embodiments, the customization specifies a set of predefined tasks for each phase of the work stream. For each task, the user may identify steps for performing each task. The predefined tasks are general tasks that are defined for multiple products in one or more embodiments. In other words, the predefined tasks are defined in the deployment framework prior to customization of the deployment framework for a particular product. When the user selects the work stream and the plan phase is presented to the user, the set of predefined tasks is presented to the user. Thus, the user is guided through customizing the deployment framework for the particular product. In one or more embodiments, the plan phase may be presented automatically to the user after the user selects the work stream or the user may further select the plan phase.

In 807, the instruments for each task in the plan phase of the work stream are gathered in one or more embodiments. In one or more embodiments, for each of the tasks in the work stream, the user identifies which tools will be required or useful to generate the task. The customization interface guides the user through creating instruments or adding references to existing instruments. The customization interface may guide the user through customizing the deployment framework by successively presenting the user with input boxes and fields for each type of instrument and for each task. In one or more embodiments, the types of instruments are discussed above and shown in FIG. 3. Specifically, the customization interface may present the user with a task and request that the user provide a set of experts that may be contacted to complete the task. As another example, the customization interface may present the user with an input box that the user may use to submit a reference to templates, presentations, software tools and other instruments. The user may gather the instruments based on the user's own knowledge, an external knowledgebase of the provider system, and from other users.

In 809, the plan phase instruments are stored in the deployment framework in one or more embodiments. Specifically, documents and references to tools are stored in the data repository.

In 811, general steps for the implementation phase are identified in one or more embodiments. In one or more embodiments, block 811 may be completed similar to block 805 as discussed above.

In 813, the instruments for each task in the implementation phase of the work stream are gathered in one or more embodiments. In one or more embodiments, block 813 may be completed similar to block 807 as discussed above.

In 815, the implementation phase instruments are stored in the deployment framework in one or more embodiments. In one or more embodiments, block 815 may be completed similar to block 809 as discussed above.

In 817, general steps for the optimize phase are identified in one or more embodiments. In one or more embodiments, block 817 may be completed similar to block 805 as discussed above.

In 819, the instruments for each task in the optimize phase of the work stream are gathered in one or more embodiments. In one or more embodiments, block 819 may be completed similar to block 807 as discussed above.

In 821, the optimize phase instruments are stored in the deployment framework in one or more embodiments. In one or more embodiments, block 821 may be completed similar to block 809 as discussed above.

In 823, a determination is made whether another work stream exists in one or more embodiments. If another work stream exists, then the flow may continue to block 803 for customizing the deployment framework for the next work stream.

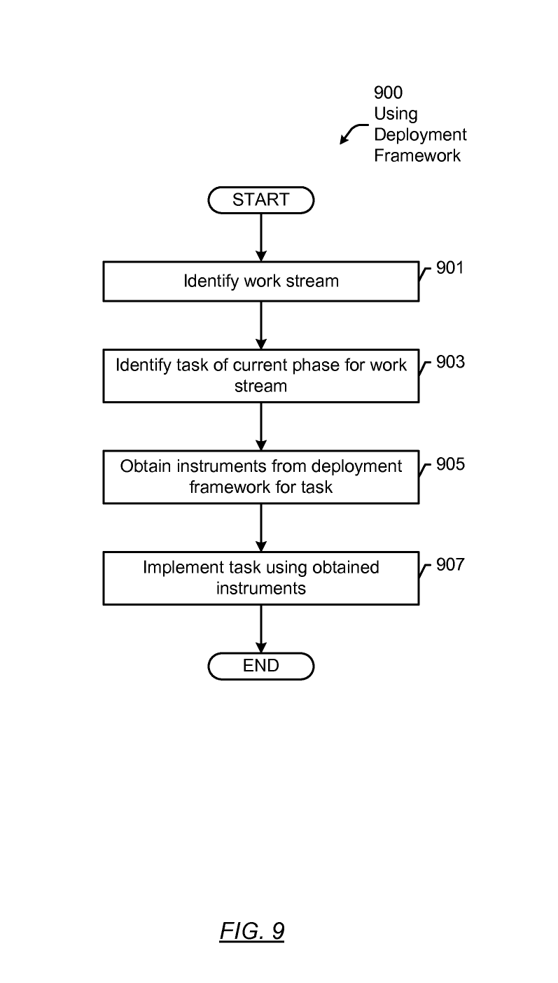

FIG. 9 shows a flowchart for using the deployment framework (900) in one or more embodiments. The various steps of FIG. 9 may be performed in parallel across multiple work streams. For example, while infrastructure renewal is being performed, user training and support may be performed. In some embodiments, the transition to a next phase is performed only after all work streams have completed the prior phase. In other embodiments, the transition may occur while one or more work streams are implementing a prior phase. In one or more embodiments, in 901, the work stream that the user is in is identified. Specifically, in one or more embodiments, users at a provider are assigned to a particular work stream. The assignment may be based on the set of skills required for the user to complete the work stream.

In 903, the task of the current phase for the work stream is identified. In one or more embodiments, tasks may, although not required, be performed sequentially. In such a scenario, the task is the next task for the phase. In one or more embodiments, identifying the next task is performed by accessing the current phase of the identified work stream of the deployment framework. A task may be obtained from the defined tasks documentation in the instruments.

In 905, instruments for the task are obtain in one or more embodiments.

For example, the user may read the documentation, follow references to templates, and software tools, and perform other functions to obtain the instruments.

In 907, the task is implemented using the obtained instruments in one or more embodiments. Specifically, the instruments guide the user through completing the task.

Because the deployment framework divides a deployment project into tasks and workflows and provides users with instruments for completing each task, the deployment framework simplifies the deployment of a product on the client environment. Specifically, the deployment framework may partition a large scale deployment project into discretize tasks that simplify the deployment while at the same time maintaining the interrelationships between personnel, hardware, software, and other aspects of the client environment.

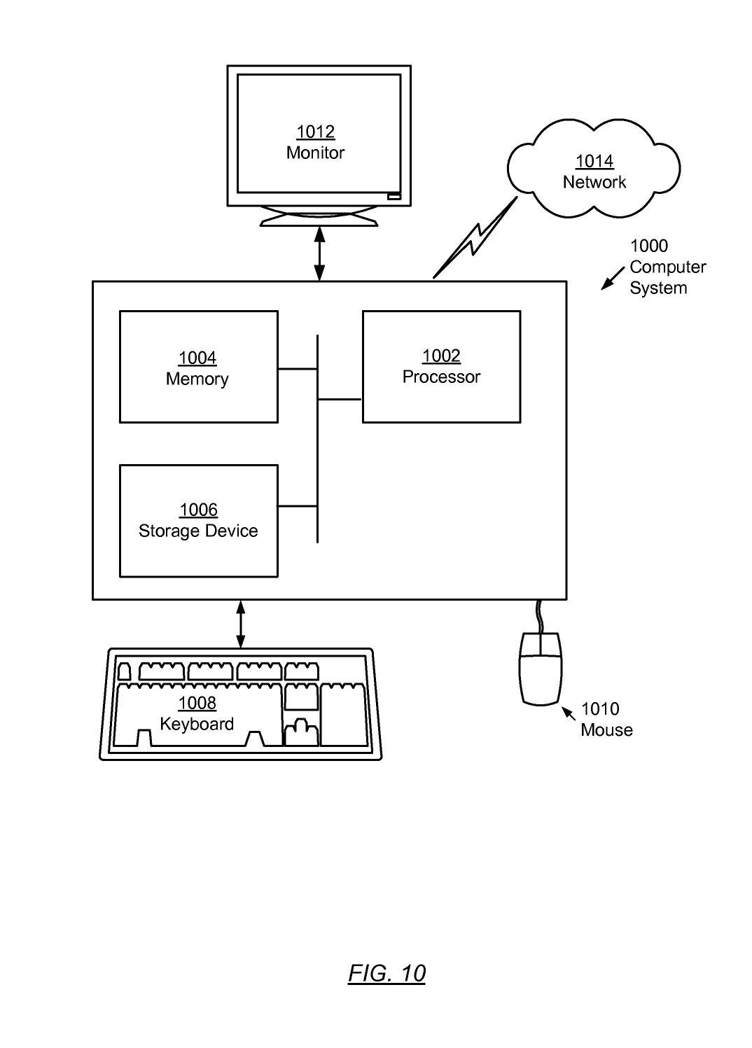

Embodiments of the deployment framework may be implemented on virtually any type of computer regardless of the platform being used. For example, as shown in FIG. 10, a computer system (1000) includes one or more processor(s) (1002), associated memory (1004) (e.g., random access memory (RAM), cache memory, flash memory, etc.), a storage device (1006) (e.g., a hard disk, an optical drive such as a compact disk drive or digital video disk (DVD) drive, a flash memory stick, etc.), and numerous other elements and functionalities of today's computers (not shown). The computer (1000) may also include input means, such as a keyboard (1008), a mouse (1010), or a microphone (not shown). Further, the computer (1000) may include output means, such as a monitor (1012) (e.g., a liquid crystal display (LCD), a plasma display, or cathode ray tube (CRT) monitor). The computer system (1000) may be connected to a network (1014) (e.g., a local area network (LAN), a wide area network (WAN) such as the Internet, or any other type of network) via a network interface connection (not shown). Those skilled in the art will appreciate that many different types of computer systems exist, and the aforementioned input and output means may take other forms. Generally speaking, the computer system (1000) includes at least the minimal processing, input, and/or output means to practice embodiments.

Further, those skilled in the art will appreciate that one or more elements of the aforementioned computer system (1000) may be located at a remote location and connected to the other elements over a network. Further, embodiments may be implemented on a distributed system having multiple nodes, where each portion (e.g., data repository, interfaces, etc.) may be located on a different node within the distributed system. In one embodiment, the node corresponds to a computer system. The node may correspond to a processor with associated physical memory. The node may correspond to a processor or micro-core of a processor with shared memory and/or resources. Further, software instructions to perform embodiments of the deployment framework may be stored on a computer readable medium such as a compact disc (CD), a diskette, a tape, or any other non-transitory computer readable storage device.

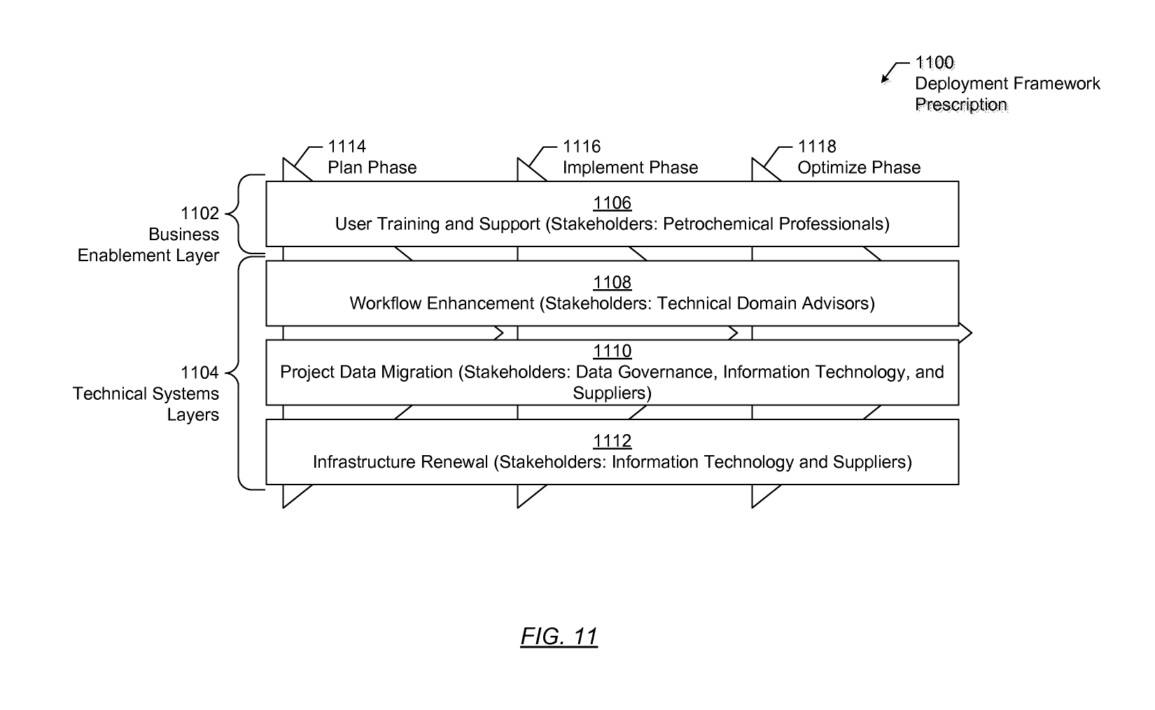

FIG. 11 provides an example schematic diagram of the prescription (1100) provided by the deployment framework for deploying an oilfield product in one or more embodiments. FIG. 11 is for example purposes and not intended to limit the scope of the claims. As shown in FIG. 11, the deployment framework separates the deployment into a Business enhancement layer (1102) and a Technical Systems Layer (1104). The business enhancement layer (1102) focuses on the business aspects of deploying the oilfield product. In one or more embodiments, the business enhancement layer (1102) include the work stream of user training and support (1106). As shown in FIG. 11, the stakeholders, or the group of individuals or departments who are affected by the deployment, include Petrotechnical professionals. Petrotechnical professionals are people who perform Petrotechnical analysis and manage the extraction of hydrocarbons.

The technical systems layer (1104) focuses on the technical aspects of deploying the oilfield product, such as changes to be made from a technical side. Specifically, the technical systems layer (1104) includes workflow enhancement work stream (1108), project data migration work stream (1110), and infrastructure renewal work stream (1112). Workflow enhancement work stream (1108) includes managing the integration and/or consolidation of existing workflows provided by existing products with the workflow performed by the oilfield product. The stakeholders of workflow enhancement are technical domain advisors.

The project data migration work stream (1110) focuses on data discovery, data cleanup, and data migration from the legacy system as well as the setup and population of a knowledgebase. In one or more embodiments, the goal of project data migration stream (1110) is to provide an easy access to quality assured data in a structured data environment, and avoid traditional issues like data duplication. The stakeholders for project data migration may include data governance department, information technology department, and suppliers.

The infrastructure renewal work stream (1112) focuses on the transition to a petro-technical infrastructure optimized for the oilfield activities. The infrastructure renewal work stream (1112) may affect servers, network, workstations and system software, and has a goal of maintaining and increasing performance and stability. The stakeholders for the infrastructure renewal work stream (1112) include information technology department and suppliers.

In the first Plan Phase (1114), the Framework is used to engage deployment services with customer stakeholders and to provide tasks for each work stream. The plan phase (1114) is supported by artifacts, such as alignment workshop guidelines and materials and situation, and effort, risk and gap assessment tools. In one or more embodiments, the objective of the plan phase in the example is to secure early agreement on measurable deployment outcome, scope, design and planning with an understanding of risk, in readiness for the next phase, which is the implement phase (1116). In one or more embodiments, the plan phase (1114) includes assigning responsibility for each step of the implement phase. The tasks in the plan phase (1114) may include project scoping for the oilfield product, assessment, solution validation, finalizing the design, and rolling out the plan.

In the implement phase (1116), the deployment framework may provide tasks, detailed assessment and design tools, recommendations and best practices, checklists and assurance procedures for each of the work streams. The objective of the implement phase (1116) may include a steady delivery of the oilfield product that leads to roll-out the product and going live with the product. The tasks in the implement phase (1116) may include go live factory readiness at the provider system, on-boarding at the client environment, configuring the oilfield product at the client environment, going live at the client environment, and performing sustaining steps at the client environment.

In the optimize phase (1118), the deployment framework may describe recurring activities that are sustained to insure the realization of value over time, including monitoring of performance indicators, implementation of user support services, continuing education services, workflow consulting services, information and knowledge management services as well as infrastructure services. The optimize phase (1118) may continually generate value through the optimum consumption of the oilfield product through the business enablement layer (1102), supported by the technical system layer (1104).

In one or more embodiments, the deployment framework may combine the interrelated elements of a successful technology deployment into a level that may be understood by stakeholders. The deployment framework may provide a container where detailed activities, templates, tools, and best practices specific to a particular technology may be capitalized for re-use across multiple client environments. Further, the deployment framework may provide a relevant management context for objective definition, stakeholder alignment, ownership assignment, progress monitoring, gap identification, and for project and change management activities. Thus, the deployment framework may provide for de-risking in technology deployment. In one or more embodiments, the deployment framework may be used to analyze past deployment failures or disappointments by supporting the research of root causes of failure in forensic analysis. The deployment framework assessment tools and best practices may contribute to the definition of a remedial plan.

One or more embodiments of the technology transition framework are performed in synergy with the technical assessment of the technology (e.g., product) by the customer, as one or more embodiments directly impact the return on investment in the technology. In one or more embodiments, the deployment framework is engaged during the technology technical and commercial evaluation, or immediately after selection of the technology.

One or more embodiments assess and de-risk new technology introduction, enhance performance of enterprises through new technology introduction, remediate substandard technology deployment, and assist in commercial services involving licensed software platforms.

Although only a few example embodiments have been described in detail above, those skilled in the art will readily appreciate that many modifications are possible in the example embodiments without materially departing from the technology transition framework. Accordingly, all such modifications are intended to be included within the scope of this disclosure as defined in the following claims. In the claims, means-plus-function clauses are intended to cover the structures described herein as performing the recited function and not only structural equivalents, but also equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for deploying a product through a plurality of phases, comprising:
defining a plurality of work streams for deploying the product, wherein each work stream of the plurality of work streams is defined for a set of components of a client environment; and
for each work stream of the plurality of work streams and for each phase of the plurality of phases:
identifying a set of predefined tasks for the phase, wherein the set of predefined tasks for the phase is common amongst the plurality of work streams,
gathering, by a computer processor, for the phase, a set of instruments specific to the work stream for performing the set of predefined tasks, and
storing the set of instruments in a data repository of a deployment framework.

2. The method of claim 1, further comprising:
for each phase of the plurality of phases of deploying the product:
selecting a selected work stream from the plurality of work streams,
obtaining a set of instruments corresponding to the phase and the selected work stream, and
executing the set of predefined tasks defined for the selected phase and the selected work stream using the set of instruments.

3. The method of claim 1, wherein the plurality of phases comprises a plan phase, an implement phase, and an optimize phase.

4. The method of claim 3, wherein the set of predefined tasks for the plan phase, and for a work stream of the plurality of work streams, comprises:
identifying a scope of a portion of the deployed product relating to the work stream,
assessing a state of the client environment with respect to the portion of the deployed product relating to the work stream,
validating the portion of the deployed product relating to the work stream on the client environment,
finalizing a design of the portion of the deployed product relating to the work stream, and
creating a roll out plan for the portion of the deployed product relating to the work stream.

5. The method of claim 3, wherein the set of predefined tasks for the implement phase, and for a work stream of the plurality of work streams, comprises:
confirming readiness of the client environment with respect to a portion of the deployed product relating to the work stream,
preparing resources for deployment on the client environment with respect to the portion of the deployed product relating to the work stream,
executing build tasks on the client environment with respect to the portion of the deployed product relating to the work stream,
transitioning the client environment to using the portion of the deployed product relating to the work stream, and
monitoring the client environment with respect to the portion of the deployed product relating to the work stream.

6. The method of claim 3, wherein the set of predefined tasks for the optimize phase, and for a work stream of the plurality of work streams, comprises:
monitoring a portion of the deployed product relating to the work stream, and
correcting a source of degradation of the client environment discovered during monitoring the portion of the deployed product relating to the work stream.

7. The method of claim 3, wherein the set of predefined tasks for the optimize phase, and for a work stream of the plurality of work streams, comprises:
monitoring a portion of the deployed product relating to the work stream, and
enhancing the client environment with an enhancement identified during monitoring the portion of the deployed product relating to the work stream.

8. A deployment framework comprising:
a data repository storing a set of instruments; and
a computer processor, which when executing a deployment application, creates:
a customization interface configured to:
receive a plurality of work streams,
present a plurality of phases for each of the plurality of work streams, and
for each phase of the plurality of phases:
receive the set of instruments for completing a plurality of tasks of the phase, the plurality of tasks common to each of the plurality of work streams, wherein the set of instruments is defined for the phase and a work stream of the plurality of work streams, and
store the set of instruments, and
a deployment interface configured to:
receive a selected work stream from the plurality of work streams and a selected phase from the plurality of phases, and
present, in response to receiving the selected phase and the selected work stream, the plurality of instruments corresponding to the selected work stream and the selected phase.

9. The deployment framework of claim 8, wherein the set of instruments for at least one work stream of the plurality of work streams comprises a defined tasks document, a deliverable document, a document tool, and an expert list.

10. The deployment framework of claim 8, wherein the set of instruments for at least one work stream of the plurality of work streams comprises a software tool and a hardware tool.

11. The deployment framework of claim 8, wherein the set of instruments for at least one work stream comprises a skill set list for a phase of the work stream.

12. The deployment framework of claim 8, wherein the plurality of phases comprises a plan phase, an implement phase, and an optimize phase.

13. The deployment framework of claim 12, wherein the set of predefined tasks for the plan phase, and for a work stream of the plurality of work streams, comprises:
identifying a scope of a portion of the deployed product relating to the work stream,
assessing a state of the client environment with respect to the portion of the deployed product relating to the work stream,
validating the portion of the deployed product relating to the work stream on the client environment,
finalizing a design of the portion of the deployed product relating to the work stream, and
creating a roll out plan for the portion of the deployed product relating to the work stream.

14. The deployment framework of claim 12, wherein the set of predefined tasks for the implement phase, and for a work stream of the plurality of work streams, comprises:
confirming readiness of the client environment with respect to a portion of the deployed product relating to the work stream,
preparing resources for deployment on the client environment with respect to the portion of the deployed product relating to the work stream,
executing build tasks on the client environment with respect to the portion of the deployed product relating to the work stream,
transitioning the client environment to using the portion of the deployed product relating to the work stream, and
monitoring the client environment with respect to the portion of the deployed product relating to the work stream.

15. The deployment framework of claim 12, wherein the set of predefined tasks for the optimize phase, and for a work stream of the plurality of work streams, comprises:
monitoring a portion of the deployed product relating to the work stream, and
correcting a source of degradation of the client environment discovered during monitoring the portion of the deployed product relating to the work stream.

16. The deployment framework of claim 12, wherein the set of predefined tasks for the optimize phase, and for a work stream of the plurality of work streams, comprises:
monitoring a portion of the deployed product relating to the work stream, and
enhancing the client environment with an enhancement identified during monitoring the portion of the deployed product relating to the work stream.

17. The deployment framework of claim 12, wherein the plurality of work streams are defined for equipment of the client environment, end users of the client environment, and at least one computer system of the client environment.

18. A non-transitory computer readable medium comprising computer readable program code for deploying a product through a plurality of phases, the computer readable program code for:
defining a plurality of work streams for deploying the product, wherein each work stream of the plurality of work streams is defined for a set of components of a client environment; and
for each work stream of the plurality of work streams and for each phase of the plurality of phases:
identifying a set of predefined tasks for the phase, wherein the set of predefined tasks for the phase is common amongst the plurality of work streams,
gathering, for the phase, a set of instruments specific to the work stream for performing the set of predefined tasks, and
storing the set of instruments in a data repository of a deployment framework.

19. The non-transitory computer readable medium of claim 18, further comprising computer readable program code for:
for each phase of the plurality of phases of deploying the product:
selecting a selected work stream from the plurality of work streams,
obtaining a set of instruments corresponding to the phase and the selected work stream, and
executing the set of predefined tasks defined for the selected phase and the selected work stream using the set of instruments.

20. The non-transitory computer readable medium of claim 18, wherein the plurality of phases comprises a plan phase, an implement phase, and an optimize phase.
